(19) United States
(12) Patent Application Publication
(10) Pub. No.: US 2009/0068051 A1
(43) Pub. Date: Mar. 12, 2009

(54) METHODS OF FORMING NANO-STRUCTURED MATERIALS INCLUDING COMPOUNDS CAPABLE OF STORING AND RELEASING HYDROGEN

(76) Inventor: Karl Gross, Fremont, CA (US)

Correspondence Address: STEVEN VOSEN, 1563 SOLANO AVENUE #206, BERKELEY, CA, 94707, US

(21) Appl. No.: 11/871,789

(22) Filed: Oct. 12, 2007

Related U.S. Application Data
(60) Provisional application No. 60/829,351, filed on Oct. 13, 2006.

(51) Int. Cl. B22F 3/11; C09K 3/00; B21C 23/06

(52) U.S. Cl. 419/2; 252/182.35; 148/688; 148/692

(57) ABSTRACT

Methods of forming materials that contain hydrogen storage materials and nano-structured matrices are described. In one embodiment, the hydrogen storage material is a complex hydride. In another embodiment, the method includes melting at least one compound capable of storing and releasing hydrogen, obtaining an aluminum-containing nano-structured matrix having a melting point higher than the temperature of the at least one compound, and contacting the molten at least one compound with the nano-structured matrix to facilitate the coating of the nano-structured material with the molten at least one compound. The matrix may undergo mechanical working to further modify the nano-structure. In yet another embodiment, the method includes forming a powder including a gas-atomized aluminum-containing powder, and pressing or sintering the powder to form a matrix, such that the matrix has nano-meter scale pores.

### CROSS-REFERENCE TO RELATED APPLICATIONS

This application claims the benefit of U.S. Provisional Application No. 60/829,351, filed Oct. 13, 2006. The entire contents of the above-listed provisional application are hereby incorporated by reference herein and made part of this specification.

### BACKGROUND OF THE INVENTION

1. Technical Field

The present invention relates to methods of forming materials that contain compounds capable of storing and releasing hydrogen, and more specifically to methods of forming nano-structured materials containing hydrogen storage materials.

2. Description of the Prior Art

Today's competing technologies for hydrogen storage include high-pressure tanks, liquid storage and reversible chemical reactions such as hydride formation. The use of hydrogen for energy storage and utilization depends, in part, on the ability to store hydrogen in a reversible system at higher than gas densities.

Many hydrogen storage materials, whether considered reversible or not (generally meaning on-board reversible) have hydrogen release and take up properties that are either too stable or too unstable for the applications of interest. These applications cover a wide range of hydrogen utilization from fuel cell or internal combustion hydrogen automobiles, portable electronic devices, portable or stationary power supplies, power rechargers, to analytical instruments such as gas chromatographs. Thus, for example, some hydrogen storage materials have hydrogen release and/or take up rates that are thermodynamically too stable, requiring higher temperatures for the release of hydrogen at about 1 atmosphere than is generally available from the waste heat only.

Prior art attempts have been made to increase the ability of hydrogen storage materials, such as hydrides, by incorporating compounds that may form such materials into supports having a high surface area-to-volume ratio. Supports having nano-sized pores are good candidates for such supports. It has recently been shown (“Magnesium-Carbon Nanocomposites for Hydrogen Storage” R. W. Wagemans, T. M. Eggenhuisen, K. P. de Jongh,—Inorganic Chemistry—Utrecht University, Utrecht, The Netherlands, presentation MH2006, MH2006 International Symposium on Metal-Hydrogen Systems—Fundamentals and Applications—Maui, Hi., Oct. 1-6, 2006) that nano-scale Mg materials could be prepared by using a carbon aerogel material with nano-meter pore sizes as a template. Exposing molten magnesium (temperatures exceeding 650° C.) to this carbon template results in the magnesium being wicked into the aerogel's pore structure, forming a matrix of nano-particle magnesium metal. Wagemans et al. found a significant proportion of the Mg metal demonstrated destabilization by comparison to the hydriding of bulk Mg, and that the temperature at which the material released hydrogen was significantly reduced. It is not entirely clear what physical mechanism results in the alteration of the hydrogenation thermodynamics, but it appears that nano-scaled crystallite sizes are necessary.

While the prior art has shown that some hydrogen storage materials may be deposited in a nano-structured material, the temperature exceed those at which more complex hydrides decompose. There is a need for a method for forming nano-structured hydrogen storage materials at lower temperatures.

### SUMMARY OF THE INVENTION

The present invention includes novel methods of forming nano-structured materials that include hydrogen storage materials and a light-weight, structural matrix.

In certain embodiments, a method is provided for forming a material is provided. The method includes melting at least one compound capable of storing and releasing hydrogen, obtaining an aluminum-containing nano-structured matrix having a melting point higher than the temperature of the at least one compound, and contacting the molten compound with the nano-structured matrix to facilitate the coating of the nano-structured material with the molten compound.

In certain other embodiments, a method of forming a material is provided. The method includes forming a powder including a gas-atomized aluminum-containing powder, and pressing or sintering the powder to form a matrix, such that the matrix has nano-meter scale pores.

### DETAILED DESCRIPTION OF THE INVENTION

In certain embodiments, the present invention includes methods for forming material including a gas storage material and matrix. Embodiments for forming the gas storage material, the matrix, and combining the gas storage material and matrix are described herein. It is understood that the various methods may be combined to form a material that includes a gas storage material and matrix. It is also understood that one skilled in the art would appreciate that modifications to the methods described herein fall within the scope of the present invention.

### Gas Storage Materials

A variety of gas storage materials may be used in this invention. The term “gas storage material” as used herein refers without limitation to a compound capable of storing and releasing a gas, and a “hydrogen storage material” as used herein refers to a gas storage material capable of storing and releasing hydrogen gas. Examples of gas storage materials include, but are not limited to, materials for hydrogen storage and other types of gas storage materials such as oxygen containing materials, ammonia containing materials, nitrogen containing materials, carbon dioxide containing materials. For hydrogen storage, these gas storage materials may include metal hydrides, intermetallic hydrides, ionic hydrides, boro-hydrides, alanates, alane, alkali-earth hydrides, alkali-metal hydrides, alkali-metal-aluminum-amides and alkali-metal-boro-amides, rare-earth hydrides, amides, and any combination of these materials.

Hydrogen storage materials based on the hydrides of alkali metals and aluminum belong to the larger class of complex hydrides. These compounds liberate copious amounts of hydrogen, either by direct thermal decomposition or by one-time hydrolysis. For example, alkali-metal amides are formed through solid-gas-phase chemical reactions involving a complete chemical composition change on going from the precursor to the hydrided compounds. In like manner, hydrogen stored in these amides is released through chemical decomposition reactions (see, for example, P. Chen, Z. Xiong, J. Luo, J. Lin, K. L. Tan, Nature, 420 (2002), W. Luo, Journal of Alloys and Compounds, 381 (2004), 284.). Hydrogen is absorbed and desorbed in reversible reactions in the better known Na—Al—H system (see, for example, C. M. Jensen and K. J. Gross, Appl. Phys. A 72, 213-219 (2001)). LiH is a decomposition product of the Li₃AlH₆ and LiAlH₄ hydrogen release reactions and LiH is a necessary component for the release of hydrogen from Li-amides. Other complex hydrides that are believed to be useful for storing hydrogen have, for example, the formula of M_{y}(N H_{4+z})ₓ where M is an alkaline, alkaline earth metal or transition metal such as sodium, lithium, calcium, magnesium, zirconium, or iron; N is aluminum or boron, X has a value of between 1 and 4; Y has a value of between 1 and 6; and Z has a value of 0 or 2.

### Nano-Structured Matrices

A number of different nano-porous materials may be used as the template for forming nano-sized gas storage materials, or for use as a nano-structured matrix to permanently form and retain the nano-sized gas storage materials. The term “nano-structured” or “nano-porous” as used herein refers, without limitation, to a material possessing a repeated but not necessarily ordered structure of pores or solid material that have pore diameters or one dimensional material lengths on a nano-scale (10⁻⁹ to 10⁻⁶ meters). The term “pores” as used herein includes, but is not limited to, interconnected, non-interconnected, ordered, non-ordered, channels, configurations, features, designs, and combinations thereof. For example, a macro-scale support material comprising a plurality of nano-scale features, nano-scale channels, or nano-scale pores. The term “pore” further embodies and encompasses all shapes, including, but not limited to, round and square. Other embodiments for pore, channel, and feature configurations as would be envisioned by a person of ordinary skill in the art are hereby incorporated, as well as the associated material manufacturing and/or application methods. Thus, no limitation in intended by the disclosure of the preferred embodiments.

The term “template” in reference to the materials of the present invention describes molecule(s), macromolecules, compounds, and/or material combinations that serve as patterns for the generation of other macromolecule(s), compounds, and/or features being deposited, coated, laid down, and/or polymerized. The support materials of the present invention, for example, serve as templating substrates whereby hydrogen storing and releasing materials are deposited, impregnated, coated, polymerized at the correct weight ratios, chemi-sorbed, physi-sorbed, and/or chemically bound in a fashion corresponding to the nature of the surfaces (both interior and exterior) of the substrate thereby contouring, mimicking, and/or mirroring the detail or pore structure of the substrate surface on which it is deposited or in chemical communication with. Porous silica templates have an extremely high surface area and a highly ordered pore structure, as reported by Zhao et al. Silica (SiO₂) is one support for the template reactions of the present invention by virtue of the pore structure. Porous aluminum templates also have high surface areas, as reported by Z. K. Xie, Y. Yamada, and T. Banno, Japanese Journal of Applied Physics Vol. 45, No. 32, 2006, pp. L864-L865).

The term “matrix” as used herein refers to a material with open spaces, including but not limited to pores, that can be filled or coated with a second material. Matrices include, for example, high surface area materials formulated, structured, formed, or configured so as to provide a template for combining with a hydrogen storage material. These matrices include, but are not limited to: carbon nano-tubes, graphite, herringbone or other carbon nano-fiber structures, boron-based nanotubes and other boron-nanostructured materials, nano-porous materials such as metal foams (aluminum, magnesium, silicon, germanium, titanium, calcium, nickel, iron, manganese, cobalt, tin, gallium, lithium, sodium, potassium, palladium, platinum, copper, or any combination of these as an alloy, solid solution or mixed phase system), oxides (silicon-dioxide, aluminum-oxide, magnesium-oxide, iron-oxide, calcium-oxide, germanium-oxide, manganese-oxide, titanium-oxide, tin-oxide, lithium-oxide, sodium-oxide, and any combination of these), zeolites, oxides produced from sol-gel processes, and any of the thousands of metal-organic-framework (MOF) materials.

Nano-sized materials synthesis or silicon-containing compounds may be prepared by the initial reaction of the metal silicide, Mg₂Si, with either SiCl₄ or Br₂ and, subsequently, with LiAlH₄ (see, for example, “A new synthetic route for the synthesis of hydrogen terminated silicon nanoparticles” QI LIU, KAUZLARICH Susan M. Department of Chemistry, University of California, Davis, One Shields Avenue, Davis, Calif. 95616, Materials science & engineering. B, Solid-state materials for advanced technology and The Sixth International Conference on Atomically Controlled Surfaces, Interfaces and Nanostructures (ASCIN-6), Lake Tahoe, Calif., USA, Jul. 9-12, 2001). Matrices may also include nano-structural materials created through powder metallurgy, chemical-vapor deposition, mechanical milling, and mechanical metal-forming processes. The nano-structured matrix can be, but is not necessarily composed of a regular or ordered structure. Thus it may be ordered as in MOFs, carbon nanotubes, and zeolites or disordered as in cold-worked metal materials.

In another embodiment, the nano-structured matrix provides structural support for the gas storage vessel. In one embodiment, the nano-structural material incorporating the hydrogen storage material is sealed using, for example, a polymer, glass, resin, or metal coating. The bulk material is then fiber-wrapped with or without resins or glues to provide a structural gas containing pressure tank. The nano-structured material may then be processed in many different ways to provide the skeletal structure of the pressure tank in any shape or form. In one embodiment, carbon nano-porous materials containing hydrogen storage materials may be formed by the chemical synthesis process or by machining into rods with a wide range of aspect ratios (including, but not limited to long rods or short cylinders) these would then be sealed and strengthened by fiber wrapping to produce a porous gas storage vessel with the properties of both physical compressed gas and chemical storage for high weight capacity storage of gases including but not limited to hydrogen.

Introduction of Gas Storage Materials into the Nano-Structured Matrix

The gas storage material/nano-structural matrix structure may be formed using a variety of techniques including, but not limited to: introducing the gas storage material into a formed matrix; co-forming the gas storage material matrix; using metal-working processes on mixtures of nano- or micro-sized powders; or compression of mixed metal powders, or of metal and non-metal powders, and rolling to thin the material into a nano-structured matrix. Examples of each of these techniques follow.

Gas Storage Material Introduced into a Formed Matrix

The gas storage material may be introduced into the nano-structural matrix using one or more of the following methods: melting and wicking into the nano-structural matrix, flowing a vapor of the storage material through the matrix to cool and deposit in the matrix, flowing a chemical liquid through the matrix and depositing within the matrix by chemical reactions, cooling or evaporation of the carrier liquid.

As examples of wicking or flowing a gas storage material into the nano-structured matrix, are the gas storage material NaAlH₄, which melts at 182° C., LiBH₄, which melts at 268° C., LiAlH₄, which melts at 137° C., or the materials NaAlH₄, LiAlH₄ or LiBH₄ dissolved in tetrahydrofuran or ether.

### Co-Forming the Gas Storage Material Matrix

The gas storage material may also be co-formed with the matrix. Co-forming the gas storage material and nano-structured matrix may be achieved by co-precipitation, for example, by co-vapor deposition or by sol-gel processes, gas atomization processes, in-situ metal vapor-deposition during carbon nano-structured material growth, wet-chemical precipitation of gas storage materials during or after the wet-chemical synthesis of MOFs, or co-production of nano-powder storage and structural materials during nano-silicon particle synthesis.

Gas atomization is an established method of fabricating fine metal powders by liquid metal atomization using close-coupled nozzle technology. Gas atomization is used, for example, in powder metallurgy manufacturing as well as a variety of other industrial uses. Gas atomization may, for example, include a close-coupled nozzle arrangement, where molten metal is fed through a central tube surrounded by a coaxial gas nozzle. The nozzle generates a high-velocity gas stream that disintegrates the slower melt stream into fine droplets, which then freeze in-flight into solid powder particles. See, for example, GAS ATOMIZATION PROCESSING EFFECTS ON HYDRIDING BEHAVIOR OF AB₅ ALLOYS FOR BATTERY APPLICATION. Jason Ting, Iver E. Anderson, Vitalij K. Pecharsky, Iowa State University, Ames Laboratory, Ames Iowa; Robert C. Bowman, Jr., Bugga V. Ratnakumar, Jet Propulsion Laboratory, Pasadena Calif.; Charles Witham and Brent Fultz, California Institute of Technology, Pasadena Calif., MRS SYMPOSIUM H Hydrogen in Semiconductors and Metals Apr. 13-17, 1998, and U.S. Pat. Nos. 6,074,453 and 6,481,638, incorporated herein by reference.

### Using Metal-Working Processes on Mixtures Powders

Alternatively, the gas storage material may also be introduced into/or around the structural material using metal-working processes on mixtures of nano- or micro-sized powders. As an example, micro-spheres of Mg and Al produced by gas atomization can be mixed together or perhaps co-produced by the gas atomization process. These powders can then be pressed into an ingot and cold-(or hot) rolled multiple times into thin sheets. These can be, folded, and rolled multiple times (in a processes analogous to the making of fine pastry) to produce a micro-structure in which metal grains are thinned out from micron-sized to nano-sized grains.

### Compression and Rolling of Powders

In another embodiment, nano-structural material incorporating the hydrogen storage material prepared by compression of mixed metal powders, or mixtures of metals and non-metals powders, and rolling to thin the material into a nano-structured matrix, may be formed from these sheets into: blocks, thin or thick sheets, tubes or rods. These forms may then be sealed at the surface, using a polymer, glass, resin, metal coating, or surface melting. This bulk material can then be fiber-wrapped with or without resins or glues to provide a structural gas containing pressure tank. After preparation, the nano-structured material may also be processed in many different ways (including, but not limited to, machining, vaporization, and/or etching) to provide the skeletal structure of the pressure tank in any shape or form.

Incorporation of Catalysts or Dopants into the Nano-Structured Gas Storage Materials Matrix

In another embodiment, catalysts which promote rapid gas uptake and release are incorporated into storage material or matrix at one or more of several different stages of the material processing. For example, titanium, which is known to dramatically improve the hydrogen sorption kinetics of sodium-alanates, is incorporated into the nano-structured metal matrix formed from aluminum. There are many different ways to do this.

In one embodiment, the aluminum nano-structured matrix is prepared as aluminum foam with nano-sized pores from an aluminum-titanium metal mixture. The composition of this mixture can range from a dilute solution of Ti in Al to one of the stoichiometric Al—Ti alloys (TiAl₃ to Ti₃Al).

In another embodiment, the aluminum nano-structured matrix is prepared by pressing or sintering very fine powders (1 to 100 micron diameter) of aluminum-titanium metal mixtures formed from sol-gel, vapor deposition, gas atomization or other processes. The starting mixture of titanium and aluminum used for the targets or melting ingots, can vary in composition from a dilute solution of Ti in Al (such as a ratio of 0.01:3) to one of the stoichiometric Al—Ti alloys (TiAl₃ to Ti₃Al).

In another embodiment, the aluminum nano-structured matrix is prepared by pressing or sintering very fine powders (1 to 100 micron diameter) of aluminum metal formed from sol-gel, vapor deposition, gas atomization or other processes. Before pressing, the aluminum powders are coated with titanium to form either thin or thick films (1 monolayer “thin” to 100 micron “thick”) or sub-monolayer islands of titanium on the aluminum surface by sol-gel, vapor deposition, or other processes. After depositing titanium on the surface of the aluminum powders, the powders are pressed or sintered to form a matrix with very small (nano-meter scale) pores.

In another embodiment, the aluminum nano-structured matrix and gas sorption material (Na or NaH) as well as the dopant (Ti) are prepared through multi-layered deposition of the matrix powder material (Al), coated with the dopant (Ti), and further coated by Na or NaH by sol-gel, vapor deposition, gas atomization or other processes. (1 monolayer “thin” to 100 micron “thick”) These powders can then be pressing or sintering form a nano-matrix of the active hydrogen sorption materials. In another variation of this material, the starting powder may be Na or NaH, coated with Al followed by Ti and then pressed or sintered. In another embodiment Na or NaH powders may first be coated with Ti followed by Al and then pressed or sintered. In another embodiment ball milling may replace pressing or sintering.

As in the previous example, the matrix itself may participate in the gas sorption reaction:

NaH+Al+3/2H₂→NaAlH₄ or

3NaH+Al+3/2H₂→Na₃AlH₆

Other examples of an active matrix include, but are not limited to: Mg-foams, Mg pressed or sintered powders. These materials are alternatively coated with inactive materials (including, but not limited to, oxides, such as Mg-oxide or Si-oxide, or carbon) or catalytically active materials (including, but not limited to, Ni, Pd, Pt, or rare-earths). For example, Mg powders may be coated with any of these materials by sol-gel, vapor deposition, gas atomization or other processes and then pressed or sintered to form a matrix of gas sorption material surrounding inactive or catalytically active materials.

Example mixtures of materials composed of nano-scaled particles or matrixes of gas-sorption materials include, but are not limited to: Mg and Al, Mg and Pd, Mg and Ni, Mg and SiO₂, carbon coated Mg nano-powders, Pd coated Mg nano-powders, Ni coated Mg nano-powders, Pt coated Mg nano-powders, Si coated Mg nano-powders, Mg coated Ni nano-powders, Mg coated Si nano-powders, Mg coated Carbon nano-powders, Mg coated Pd nano-powders, Mg coated Cu nano-powders, NaBH₄ nano-powders coated with Mg, NaBH₄ nano-powders coated with Ni, NaBH₄ nano-powders coated with Pd, Na—B nano-powders coated with Mg, B nano-powders coated with Mg and Na, B nano-powders coated with Mg, B nano-powders coated with Li, B nano-powders coated with Mg and Li, N-B nano-powders coated with Li, N—Li nano-powders coated with Mg, Mg—N nano-powders coated with Li.

In another embodiment, Mg-powders (sub-micron to hundreds of microns) are mixed at room temperature by hand or mechanical mixing (for 5 minutes to 20 hours) with gas-atomized Al-powders (sub-microns to hundreds of microns) which may or may not contain Titanium. These powder mixtures are then pressed with 1 to 1000 psi pressures into an ingot or pellet. The ingot or pellet is then formed into a thin sheet (1 micron to hundreds of microns) by mechanical extrusion (at room temperature to 500° C.). The thin sheet is folded over (1 to 100 times). The folded sheet is then run through the mechanical extruder again to form a new a thin sheet (1 micron to hundreds of microns). The process of extruding or rolling the thin sheet and folding it and rolling it again can be performed over and over again (1 to 500 times) to produce a material with nanometer thick grains of Mg in a matrix of Al (or Al—Ti alloy or solid solution) to produce a hydrogen storage material with thermodynamic properties that are better than bulk magnesium for hydrogen storage.

In an alternative embodiment, carbon, silicon, oxides, Pd, Ni are included in the above mixture as additives (in concentrations from 0.01-30%).

In addition to the methods described above, the combined nano-structured matrix and gas storage material may be further mechanically worked to form other structures. Thus, for example, a combined nano-structured matrix and gas storage material may be worked to form into a thin sheet (1 micron to hundreds of microns) by mechanical extrusion (at room temperature to 500° C.). The thin sheet may then be folded (from 1 to 100 times). The folded sheet may then run through the mechanical extruder again to form a new a thin sheet (1 micron to hundreds of microns). The process of extruding or rolling the thin sheet and folding it and rolling it may again be performed repeatedly (from 1 to 500 times) to produce a material with nanometer thick grains of material to produce a hydrogen storage material with thermodynamic properties that are better than bulk hydrogen storage material.

In certain embodiments, materials formed by the methods described herein may be advantageously used for gas storage. In one embodiment, the matrix provides structure to prevent the gas storage material from coalescing into larger particles thereby preventing the formation of larger particle sizes. In another embodiment, the matrix isolate very small domains of the gas storage materials to prevent long distance segregation of reacting phases such as in the alanates, amide-hydride, and destabilized hydride systems that require close proximity to react in the solid state. In yet another embodiment, the matrix isolates very small domains of the gas storage materials to prevent long distance transport of fine particles. This immobilizes the gas storage materials to prevent the transport of grains that may otherwise collect and sinter into larger particles or create problems of grain interlocking and large forces produced by lattice expansion on gas sorption (hydriding).

Reference throughout this specification to “one embodiment,” “an embodiment,” or “certain embodiments” means that a particular feature, structure, method, or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

I claim:

1. A method of forming a material comprising:
melting at least one compound capable of storing and releasing hydrogen;
obtaining an aluminum-containing nano-structured matrix having a melting point higher than the temperature of the at least one compound; and
contacting said molten at least one compound with said nano-structured matrix to facilitate the coating of said nano-structured material with said molten at least one compound.

2. The method of claim 1, where said at least one compound includes one or more of NaAlH₄, LiAlH₄, or LiBH₄.

3. The method of claim 1, where said at least one compound includes a complex hydride.

4. The method of claim 1, where said at least one compound, when molten, contains hydrogen.

5. The method of claim 1, where said nano-structured matrix includes one or more of a carbon nano-tube, graphite, herringbone or other carbon nano-fiber structures, boron-based nanotubes and other boron-nanostructured materials, nano-porous materials such as metal foams, oxides, zeolites, oxides produced from sol-gel processes, or a metal-organic-framework.

6. The method of claim 1, where the surface tension of the molten at least one compound on said nano-structured matrix facilitates wicking of the molten at least one compound into said nano-structured matrix.

7. The method of claim 1, further comprising providing a pressure difference between the molten at least one compound and said nano-structured matrix to force the molten at least one compound into said nano-structured matrix.

8. The method of claim 1 further comprising
a first extruding of said matrix into a second sheet; and
repeatedly working said matrix by:
folding a sheet of said matrix from between once and 100 times; and
an extruding of the folded first sheet to from a second sheet.

9. The method of claim 8, where said first extruding is performed at temperatures of from room temperature to 500° C.

10. The method of claim 8, where said first sheet has a thickness of from approximately 1 micron to hundreds of microns.

11. The method of claim 8, where said second sheet has a thickness of from approximately 1 micron to hundreds of microns.

12. The method of claim 8, where said repeatedly working includes folding and extruding from between once and 500 times.

13. A method of forming a material comprising:
forming a powder including a gas-atomized aluminum-containing powder; and
pressing or sintering said powder to form a matrix,
such that said matrix has nano-meter scale pores.

14. The method of claim 13, where said aluminum-containing powder is atomized from aluminum metal.

15. The method of claim 14, where said forming includes coating said gas-atomized aluminum-containing powder with titanium.

16. The method of claim 13, where said aluminum-containing powder is atomized from an aluminum and titanium mixture.

17. The method of claim 13, where said mixture contains aluminum and titanium in a ratio of from 1:3 to 3:0.01.

18. The method of claim 13, further comprising:
melting a hydrogen storage material; and
contacting the molten at least one compound with said matrix to facilitate the coating of said matrix with said at least one compound.

18. The method of claim 15, wherein
where said forming includes coating said gas-atomized aluminum-containing powder with Na or NaH.

19. The method of claim 13, where said forming includes forming a powder of Na or NaH, coating said powder with gas-atomized aluminum, and coating said powder with Ti.

20. The method of claim 13, further comprising
a first extruding of said matrix into a second sheet; and
repeatedly working said matrix by:
folding a sheet of said matrix from between once and 100 times; and
an extruding of the folded first sheet to from a second sheet.

21. The method of claim 20, where said first extruding is performed at temperatures of from room temperature to 500° C.

22. The method of claim 20, where said first sheet has a thickness of from approximately 1 micron to hundreds of microns.

23. The method of claim 20, where said second sheet has a thickness of from approximately 1 micron to hundreds of microns.

24. The method of claim 20, where said repeatedly working includes folding and extruding from between once and 500 times.
